(19) United States
(12) Patent Application Publication
(10) Pub. No.: US 2013/0152711 A1
(43) Pub. Date: Jun. 20, 2013

(54) TESTING APPARATUS FOR INPUT DEVICE

(71) Applicants: MING-MING XU, Shenzhen City (CN); XIAO-WEI WANG, Shenzhen City (CN)

(72) Inventors: MING-MING XU, Shenzhen City (CN); XIAO-WEI WANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/594,856

(22) Filed: Aug. 26, 2012

(30) Foreign Application Priority Data
Dec. 20, 2011 (CN) 201110429669.9

(51) Int. Cl. G01N 19/00

(52) U.S. Cl. 73/865.9

(57) ABSTRACT

A testing apparatus for testing an input device of an electronic device includes a testing stage, a bracket, a testing device, and a driving system. The testing stage receives the electronic device. The testing device is slidably mounted to the bracket. The testing device including a first touching member. The driving system drives the testing device to move in an X-axis, a Y-axis, and a Z-axis, such that the touching member rolls and presses on the input device. Each two of the X-axis, the Y-axis, and the Z-axis are perpendicular to each other.

### BACKGROUND

1. Technical Field

The present disclosure relates to testing apparatus, and particularly to a testing apparatus for input device.

2. Description of Related Art

Electronic devices, such as notebook computers and phones, typically include one to two types of input devices. The input devices may be a keyboard or a touch pad. These input devices are required to be tested before the electronic devices leave the factory. However, the input devices are tested manually, which consumes much time and manual labor.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an isometric view of a testing apparatus.

FIG. 2 is the testing apparatus in FIG. 1 viewing from another aspect.

FIG. 3 a cutaway view of the testing apparatus in FIG. 1.

FIG. 4 is an enlarged view of the circle portion IV in the FIG. 1.

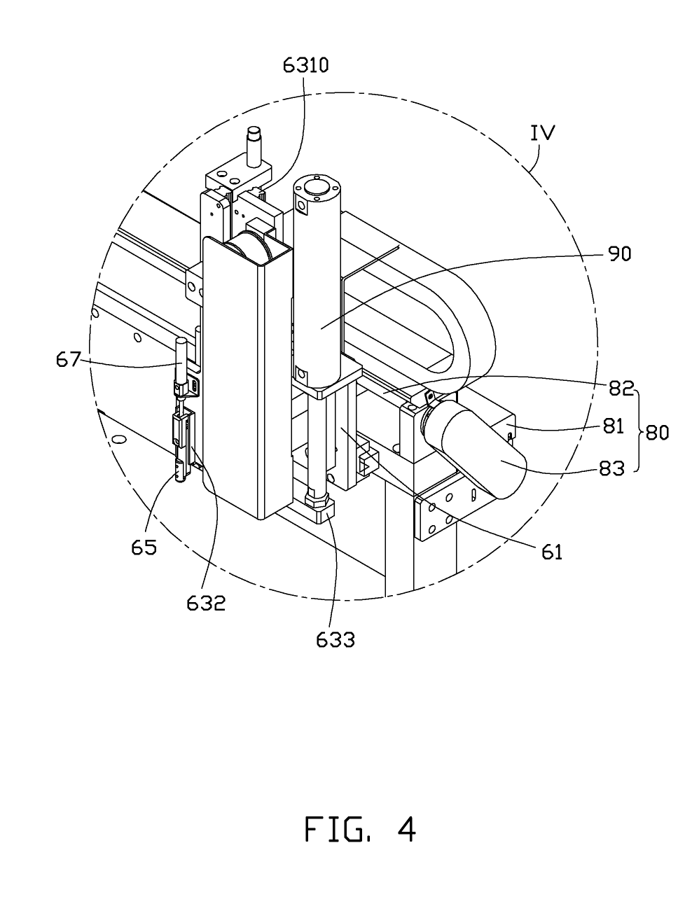

FIG. 5 is an enlarged view of the circle portion V in the FIG. 2.

### DETAILED DESCRIPTION

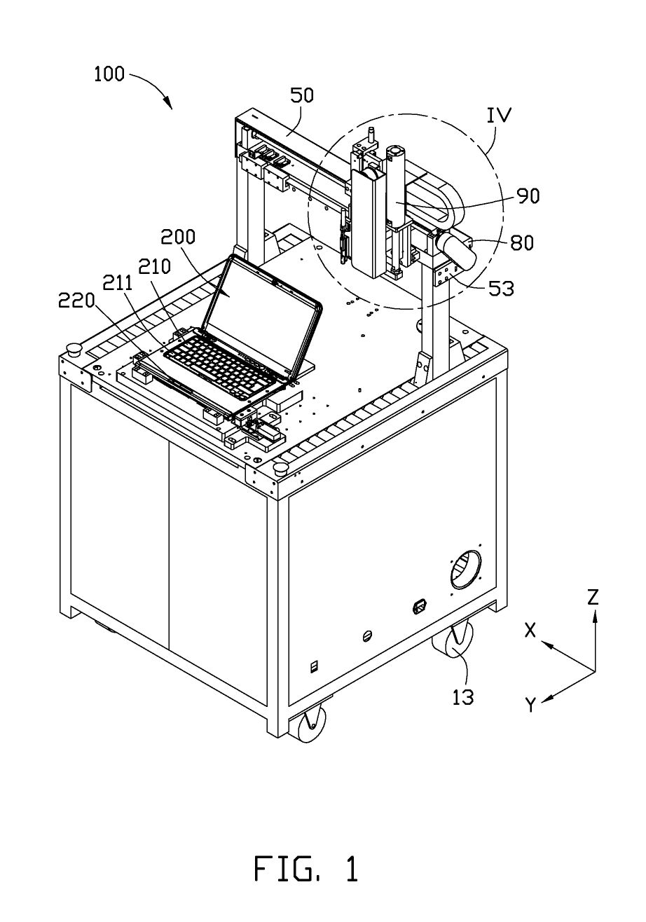

Referring to FIG. 1, a testing apparatus 100 is configured to test an input device of an electronic device. In the embodiment, the electronic device is a notebook computer 200. The input device of the notebook computer 200 includes a keyboard 210 and a touch pad 220. The keyboard 210 includes a plurality of keys 211. The touch pad 220 includes a touching portion (not shown) and two buttons (not shown).

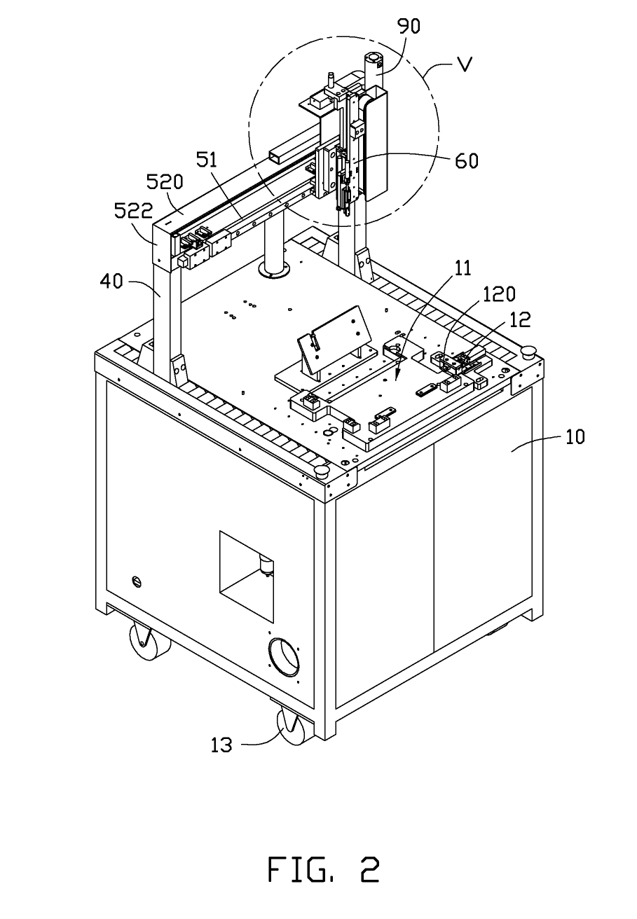

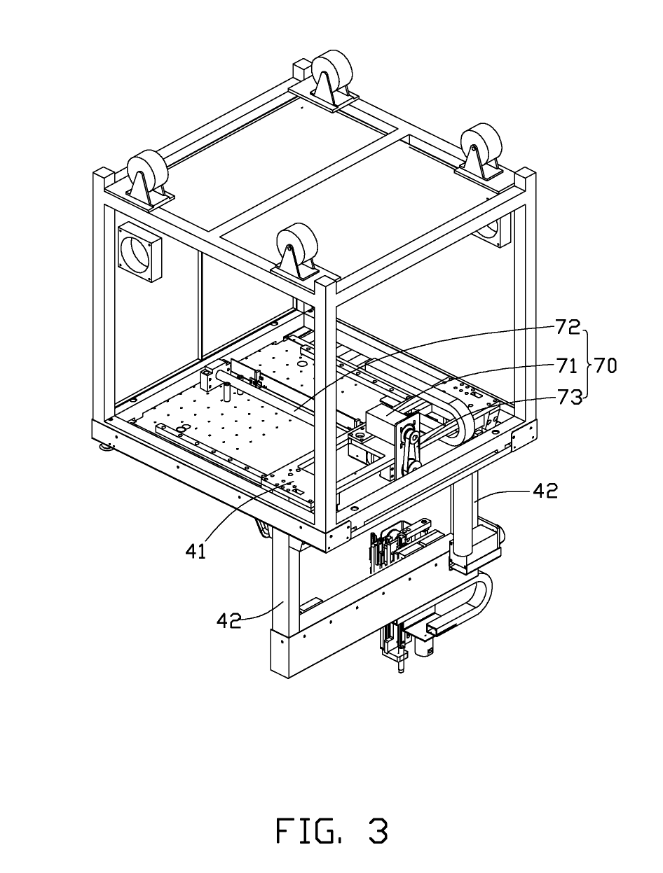

Referring to FIGS. 2-3, the testing apparatus 100 includes a testing stage 10, a vertical bracket 40, a horizontal bracket 50, a testing device 60, a first driving device 70, a second driving device, a third driving device 90, and an alarm device (not shown). The vertical bracket 40 protrudes from the testing stage 10. The horizontal bracket 50 is mounted to the vertical bracket 40. The first driving device 70, the second device 80, and the third device drive the testing device 60 to move in a Y-axis direction, an X-axis direction and a Z-axis direction respectively. Each two of the Y-axis direction, the X-axis direction and the Z-axis direction are perpendicular to each other. The testing device 60 tests the keyboard 210 and the touch pad 220. The alarm device generates alarm signal when the keyboard 210 and the touch pad 22 are tested to be abnormal.

The testing stage 10 is a hollow cube-like box. The testing stage 10 includes a top portion 101, and a bottom portion 102 away from the top portion 101. A locating device 11 and a connecting device 12 are positioned at exterior surface of the top portion 101 and adjacent to the front side of the testing stage 10. The locating device 11 is configured to receive and fasten the notebook computer 200. A connector 120, and a fourth driving device 122 for driving the connector 120 to move are located on the connecting device 12. The connector 120 is a USB connector, which is electrically connected the notebook computer 200 to the alarm device to enable the notebook computer 200 to communicate with alarm device. The structure of the fasting device 11 and the connecting device 12 is designed based on the figure of the notebook computer 200. Four wheels 13 are mounted to the bottom portion 102 to enable the test stage 10 to move.

The vertical bracket 40 includes a base 41 and two supporting shafts 42. The sliding base 41 is positioned on the inner surface of the top portion 101, and arranged in the X-axis direction. Opposite ends of the sliding base 41 are adjacent to opposite sides of the testing stage 10, and slidably secured to the inner surface of the top portion 101. One end of each supporting shaft 42 is connected to one end of the sliding base 41. The other end of the each supporting shaft 42 passes through the top of the testing stage 10 and extends upwardly.

The first driving device 70 includes a first driving motor 71, a first screw shaft 72, and a first conveyer belt 73. The first shaft 71 passes through the sliding base 41, and opposite ends of the first shaft 71 are connected to another opposite sides of the test stage 10. In other words, the first shaft 71 is arranged in the Y-axis direction. The first driving motor 71 drive the first shaft 71 to rotate via the conveyor belt 73. As a result, the vertical bracket 40 moves in the Y-axis direction.

The horizontal bracket 50 includes a sliding track 51, a fixing base 52, and a fixing block 53. The sliding track 51 is a rectangular board. The ends of the supporting shafts 42 pass through the two ends of the sliding track 51. The fixing block 53 is fixed to one of the supporting shaft 42 and located below the sliding track 51. As a result, the fixing block 53 supports one end of the sliding track 51. The fixing base 50 includes a top board 520, and a side board 522 extending downwardly from one end of the top board 520. The other end of the top board 520 away from the side board 522 is secured to the distal of the one of the supporting shaft 42. The side board 520 is secured to the other supporting shaft 42 and the other end of the sliding track 51. As a result, the sliding track 51 is secured to the vertical bracket 40.

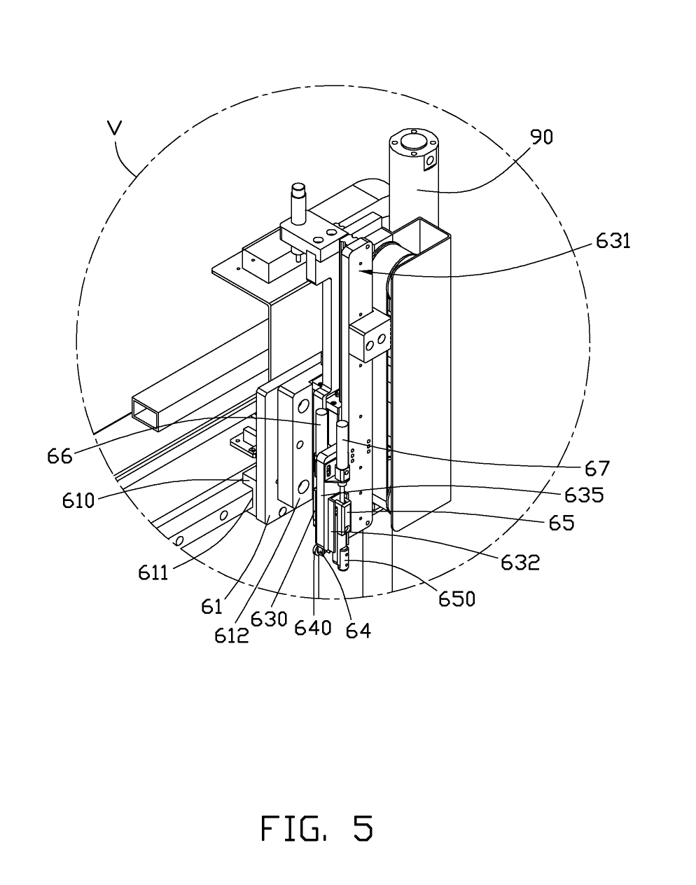

Referring to FIG. 5-6, the testing device 60 includes a connecting member 61, a mounting member 63, a first touching member 64, a second touching member 65, a fifth driving device 66, and a sixth driving device 67. The connecting member 61 is slidably mounted to the sliding track 51. The mounting member 63 is slidably mounted to the connecting member 61. The first and the second touching members 64, 65 are slidably mounted to the mounting member 63. The fifth and the sixth driving devices 66, 67 are mounted to the mounting member 63 to drive the first and the second touching member 64, 65 to move with respect to the mounting member 63.

The connecting member 61 includes a sliding block 610 and a first sliding channel 612. A sliding groove 611 is concaved in one side of the sliding block 610. The sliding track 51 is slidably received in the sliding groove 611, thus the connecting member 61 can slidably mounted to the sliding track 51. The first sliding channel 612 is secured to the other side of the sliding block 610 and away from the sliding groove 611, and the first sliding channel 612 is arranged in the Z-axis direction.

The mounting member 63 includes main body 631, a supporting member 633, and a fastening board 635. A rail 6310 protrudes from the main body 631, and the rail 6310 is arranged in the Z-axis direction. The rail 6310 is slidably received in the first sliding channel 612. The supporting member 633 is secured to the main body 631. The supporting member 633 is a rectangular board parallel to the top portion 101. The fastening board 635 protrudes from the main body 631. The fastening board 635 is a rectangular board perpendicular to the supporting member 633. A second sliding channel 630 and a third sliding channel 632 are secured to opposite side of the fastening board 635. The second sliding channel 630 faces to the horizontal bracket 50, and the third sliding channel 632 deviates from the horizontal bracket 50. The second sliding channel 630 and the third sliding channel 632 are arranged in the Z-axis direction.

The first touch member 64 and the second touch member 65 are slidably received in the second sliding channel 630 and the third sliding channel 632. A rotating wheel 640 is connected to the distal of the first touch member 64, the rotating wheel 640 faces to the top portion 101. A stick 650 is connected to the distal of the second touching member 65, the stick 650 faces to the top portion 101.

The fifth driving device 66 is secured to the fastening board 635. The fifth driving device 66 is a cylinder with a cylindrical arm connected to one end of the first touching member 64 and away from the rotating wheel 640. When the fifth driving device 66 is functioning, the cylindrical arm drives the first touching member 64 to move along the second sliding channel 630. The sixth driving device 67 is secured to the fastening board 635. The sixth driving device 67 is a cylinder with a cylindrical arm connected to one end of the second touching member 65 and away from the stick 650. When the sixth driving device 67 is functioning, the cylindrical arm drives the second touching member 65 to move along the third sliding channel 632. In other words, the first touch member 64 and the second touch member 65 are capable of moving in the Z-axis direction.

The second driving device 80 includes a second motor 81, and a second screw shaft 82, and a second conveyor belt 83. The second screw shaft 82 passes through the sliding block 610, and the opposite end of the screw shaft 82 are connected to the two supporting shafts 42. The second motor 81 drives the screw shaft 82 to rotate via the second conveyor belt 83. As a result the sliding block 610 is capable of moving with respect to the second screw shaft 82 to enable the mounting member 63 to move with respect to the second screw shaft 82. In other words, the second driving device 80 drives the testing device 60 to move in the Y-axis direction.

The third driving device 90 is secured to the sliding block 610. The third driving device 90 is a cylinder with a cylindrical arm being connected to the mounting member 63. When the third driving device 90 is functioning, the mounting member 63 is driven to move along the first sliding channel 612. In other words, the third driving device 90 drives the testing device 60 to move in the Z-axis.

In the embodiment, the testing apparatus 100 tests the keyboard 210 second then test the touch pad 220. The testing apparatus 100 tests the keyboard 210 from the back side to the front side of the keyboard 210. In the original state of the testing apparatus 100, the vertical bracket 40 locates one side of the top potion 101 away from the fastening device 11. The testing device 60 locates one end of the horizontal bracket 50 adjacent to the fixing block 53. The first touching member 64 and the second touch member 65 are away from the top portion 101. The way the testing apparatus 100 test the keyboard 210 and the touch pad 220 will be described bellow.

The notebook computer 200 is placed on the locating device 11, the notebook computer 200 is opened, and the fourth driving device 122 drives the connector 120 to be inserted into the connector (not shown) of the note book computer 200. The first driving device 70 and the second driving device 80 are started up to drive the testing device 60 to move that the first touch member 64 face to the first row of keys of the keyboard 210 away from the touch pad 220. The third driving device 90 is then started up to driving the testing device to move that the testing device 60 is adjacent to the keyboard 210. The fifth driving device 66 is started up to move the first touching member 64 to move that, the wheel 640 contacts to right side of the keyboard 210. The second driving device 80 is started again to move the testing device 60 from right side to left side of keyboard 210, as a result, the wheel 640 rolls and presses the first row of the keys one by one that the first row of keys have been tested. The fifth driving device 66 is started up to drive the first touch member 64 to move away from the keyboard 210 and the first driving device 70 is started up to drive the testing device 60 to move to the second row of keys, and then the fifth driving device 66 is started up to drive the first touch member 64 to move that the wheel 540 contacts the left side of the keyboard 210, and then the second driving device 80 is started up to move the testing device 60 to move from left side to right side of the keyboard 210, the second row of the keys have been tested. As described above, the keys of the keyboard 210 can be tested row by row, in other words, the first touching member 64 moves in a zigzag pattern.

When the all keys are tested, the fifth driving device 66 is started up to drive the first touch member 64 to move away from the keyboard 210 and the first driving device 70 is started up to drive the testing device 60 to move that the second touching member 65 faces to the touch pad 220; the sixth driving device 67 is started up to drive the second touching member 65 to move that the stick 650 contact the touch pad 220, the first or the second driving devices 70, 80 are stated up to move the testing device 60 that, the stick 650 slides on touching portion of the touch pad 220, and then the sixth driving device 67 drives the stick 650 to click the buttons of the touch pad 220.

Accordingly, when the keyboard 210 is pressed or the touch pad 220 is touched or clicked, the notebook computer 200 generates corresponding instructions. A testing software is installed and executed in the notebook computer 200 to determine whether the keyboard 210 or the touch pad 220 are normal based on the corresponding instructions. For example, when the keyboard 210 or touch pad 220 are determined to be abnormal, the notebook computer 200 generates a signal to the alarm device to control the alarm device to generate an alarm. At the same time, the testing apparatus 100 returns to the original state. The alarm device may be a loudspeaker which can generates a sound alarm when the keyboard 210 or touch pad 220 are determined to be abnormal. The alarm device may also be an LED which can generates a light alarm when the keyboard 210 or touch pad 220 are determined to be abnormal.

Even though relevant information and the advantages of the present embodiments have been set forth in the foregoing description, together with details of the functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. A testing apparatus for testing an input device of an electronic device, the testing apparatus comprising:
a testing stage configured for receiving the electronic device;
a bracket mounted to the testing stage;
a testing device slidably mounted to the bracket, the testing device comprising a first touching member;
a driving system driving the testing device to move in an X-axis, a Y-axis, and a Z-axis such that the touching member rolls and presses on the input device, each two of the X-axis, the Y-axis, and the Z-axis being perpendicular to each other.

2. The testing apparatus of claim 1, wherein the first touch member comprises a wheel to roll and press on the input device.

3. The testing apparatus of claim 1, wherein the driving system comprises a first driving device and a second driving device, the bracket comprises a vertical bracket and a horizontal bracket slidably along the vertical bracket, the testing device is slidably mounted to the horizontal bracket, the horizontal bracket is arranged in the X-axis, the vertical bracket is driven by the first driving member to move in the Y-axis, the testing device is driven by the second driving member to move in the X-axis along the horizontal bracket.

4. The testing apparatus of claim 3, wherein the driving system further comprises a third driving member to drive testing device to move in the Z-axis direction along the horizontal bracket.

5. The testing apparatus of claim 1, wherein the testing device further comprises a fourth driving member to drive testing device to move in the Z-axis direction.

6. The testing apparatus of claim 1, wherein the testing device comprises a second touching member, the second touch member slides and clicks on the input device.

7. The testing apparatus of claim 6, wherein the second touching member comprises a stick to mark and click on the input device.

8. The testing apparatus of claim 6, wherein the testing device further includes a fifth driving member to drive the second touching member to move in the Z-axis direction.

9. A testing apparatus comprising:
a testing stage configured for receiving the electronic device;
a bracket slidably mounted to the testing stage;
a testing device slidably mounted to the bracket, the testing device comprising a first touching member;
a driving system driving the testing device to move in a zigzag pattern, such that, he first touching member rolls and presses on the input device.

10. The testing apparatus of claim 9, wherein the driving system further drives the testing device to move in an Z-axis direction which is perpendicular to the input device.

11. The testing apparatus of claim 9, wherein the bracket comprises a vertical bracket protruding from the stage, and a horizontal bracket slidiably mounted to the vertical bracket, the testing device is slidably mounted to the horizontal bracket, the vertical bracket is driven to move in a Y-axis direction, the horizontal bracket is driven to move with respect to the vertical bracket in an X-axis direction, the testing device is driven to move with respect to the horizontal bracket in the Z-axis direction, the Z-axis is perpendicular with an plane formed by the X-axis and Y-axis, the testing device moves on the plane.

12. The testing apparatus of claim 9, wherein the first touch member comprises a wheel to roll and press on the input device.

13. The testing apparatus of claim 1, wherein the input device comprises a keyboard.

14. The testing apparatus of claim 9, wherein the testing device comprises a second touching member, the second touch member slides and clicks on the input device.

15. The testing apparatus of claim 13, wherein the second touching member comprises a stick to mark and click on the input device.

16. The testing apparatus of claim 14, wherein the input device comprises a touch pad.
